(19) United States
(12) Patent Application Publication
(10) Pub. No.: US 2014/0053364 A1
(43) Pub. Date: Feb. 27, 2014

(54) DRY STEAMING APPARATUS FOR PEST CONTROL AND CLEANING

(71) Applicant: Bug Elimination and Prevention Corporation, Waterloo (CA)

(72) Inventor: Kailash C. Vasudeva, Waterloo (CA)

(73) Assignee: Bug Elimination and Prevention Corporation, Waterloo (CA)

(21) Appl. No.: 13/973,095

(22) Filed: Aug. 22, 2013

Related U.S. Application Data
(60) Provisional application No. 61/692,184, filed on Aug. 22, 2012.

(51) Int. Cl. A01M 7/00; A47L 11/40

(52) U.S. Cl. CPC A01M 7/00; A47L 11/4086
USPC 15/322; 15/321

(57) ABSTRACT

The dry steamer apparatus delivers steam and heated air to produce dry steam to treat a surface as a method of eradicating bed bugs or other insect pests, and/or for cleaning purposes. The apparatus provides a vacuum to immediately remove the dry steam, and dead pests and other debris. A treatment substance dispensing assembly may also be provided, to dispense treatment substances onto the surface after steaming and vacuuming. The apparatus may incorporate the vacuum, or may attach to an external vacuum, for example the central vacuum unit of a home. Where the vacuum is part of the apparatus, the vacuum fan may have its exhaust connected to supply air to an assembly to produce the heated air, and if applicable, to the treatment substance dispensing assembly to dispense the treatment substance.

### REFERENCE TO RELATED APPLICATION

This is a formal application based on and claiming the benefit of U.S. provisional application Ser. No. 61/692,184, filed Aug. 22, 2012.

### BACKGROUND

This invention relates to apparatus for pest control and steam cleaning The apparatus treats a surface with “dry steam”, i.e. steam with little or no liquid water, and is particularly useful in eradicating insect pests, such as bed bugs for example, but may be used purely for cleaning purposes if desired.

Vacuum cleaners and steam cleaners are well known in the prior art. However, no apparatus known to the inventor has combined a vacuum cleaner and a steam cleaner in such a way as to operate at the same time and to produce dry steam to effectively treat a surface with the treated surface remaining essentially dry during and after the operation.

### SUMMARY OF THE INVENTION

In view of the above, it is an object of this invention to provide a dry steamer apparatus, which includes multiple pest control elements (potentially and preferably steam, heat, vacuum and chemical treatment substances) into a single unit in order to reduce the operating time to remove substantially all living pests, especially bed bugs, from an infested area. It is the intent that by combining the various control elements the system will more effectively isolate, remove and eliminate all or substantially all pests from a given area, and also protect the area from being re-infested.

It is also an object of the invention to provide apparatus which may be used for dry steam cleaning only, i.e. not necessarily with pest eradication at the same time.

Preferred embodiments of the invention provide a dry steamer pest control apparatus, which combines and connects a vacuum, heater and steamer in such a way that they can be operated together to produce dry steam and to keep the treated surface substantially dry during and after the operation. The dry steam is applied to the surface, and the vacuum removes it before significant condensation can occur. Or if there is some condensation, due to the surface being cold, for example, the vacuum removes the water before it has an opportunity to soak into the surface.

A preferred embodiment of the dry steamer apparatus of the invention includes: a steam generating assembly for generating and delivering steam; a vacuum assembly for drawing dead insects or other debris away from the treated surface; an air heating assembly for heating and delivering hot air to mix with the steam to produce dry steam; an optional treatment substance dispensing assembly for dispensing chemical treatment substances onto the treated surface; a mixing chamber or hose for mixing steam from the steam generating assembly and hot air from the heating element assembly; and an operating nozzle assembly, which can operate to spray a steam/heat mixture from the mixing chamber or hose onto the treated surface, and simultaneously vacuum from the treated surface.

In an alternative embodiment, the apparatus attaches to and uses a pre-existing central vacuum unit in the house or other building, instead of using a vacuum which is part of the apparatus.

### BRIEF DESCRIPTION OF THE DRAWINGS

Embodiments of the invention will now be described, by way of example only, with reference to the attached drawings, in which:

FIG. 1 is a perspective view of a first example of the dry steamer pest control apparatus of the invention (with vacuum);

FIG. 2 is a schematic representation of the apparatus of FIG. 1;

FIG. 3 is a perspective view of another example of the dry steamer pest control apparatus of the invention (combined with a central vacuum system);

FIG. 4 is a schematic representation of the apparatus of FIG. 3

FIG. 5 shows a concentric nozzle arrangement for steam and suction;

FIG. 6 shows a concentric nozzle arrangement for steam, suction and application of a treatment substance; and

FIG. 7 is a perspective view of a “backpack” version of the apparatus.

### DETAILED DESCRIPTION

In the following detailed description, reference will be made primarily to the apparatus as configured for eradication of bed bugs or other insect pests. However, it should be understood that the apparatus can be used strictly for dry steam cleaning if desired, with no intention to treat for bed bugs or other insect pests. In such embodiments, obviously the treatment substance dispensing assembly described below is not required. However, if the apparatus does have a treatment substance dispensing assembly, obviously it can still be used for purely steam cleaning, with the treatment substance dispensing assembly simply not being used, or possibly being used to dispense some other cleaning product or disinfectant or the like.

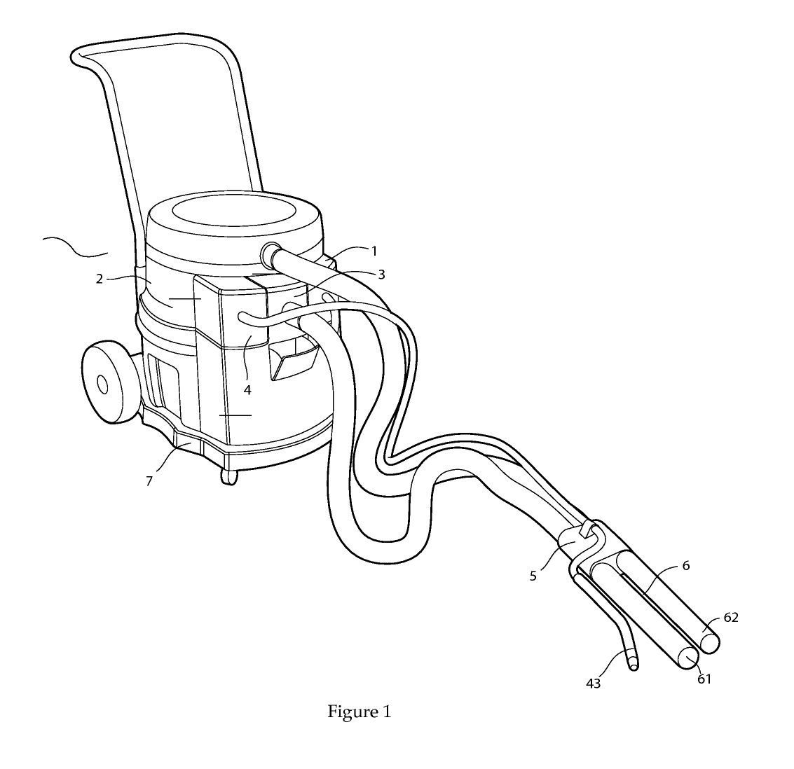

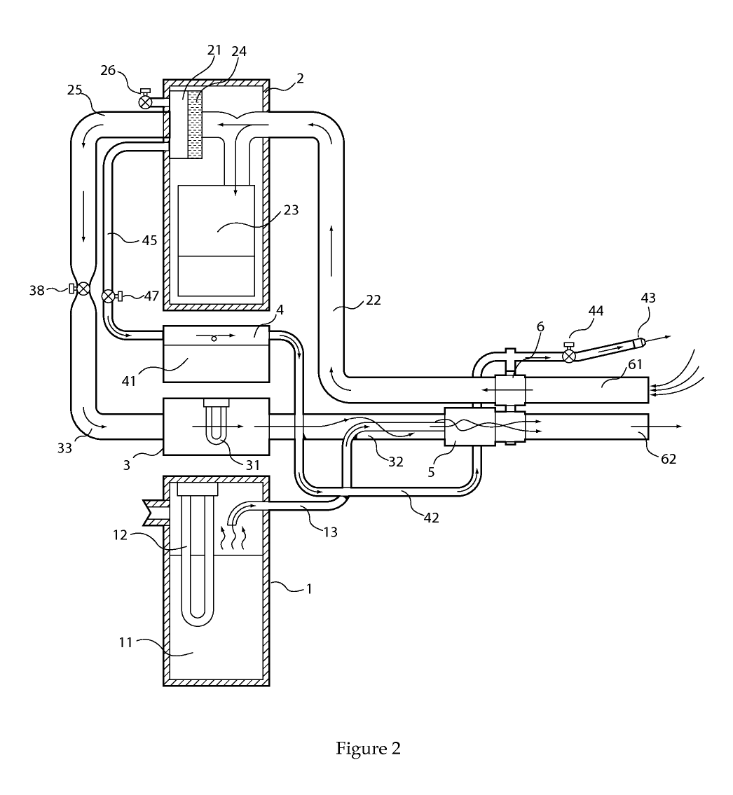

FIGS. 1 and 2 illustrate a first example of the invention. The apparatus includes: a steam generating assembly 1 for generating and delivering steam; a vacuum assembly 2 for drawing the exterminated bugs and other debris away from a treated surface; an air heating assembly 3 for heating air exhausted from the vacuum assembly 2, and delivering the heated air to the treated surface; a treatment substance dispensing assembly 4 for dispensing chemical treatment substances onto the treated surface; a mixing chamber 5 for mixing steam from the steam generating assembly 1 and hot air from the air heating assembly 3; and an operating nozzle assembly 6, for spraying the steam/heat mixture from the mixing chamber 5 and at the same time applying suction from the vacuum assembly 1.

The steam generating assembly 1 preferably includes a water reservoir 11, a heating element 12 by which the water is turned into steam, and an insulated steam hose 13 to transfer steam to the mixing chamber 5. The heating element 12 is submerged in the water reservoir 11. Distilled water is preferred, to minimize mineral accumulation.

Optionally, the heating element 12 can be separate from the reservoir 11. In such an embodiment, the steam generating assembly 1 preferably would employ a pump (not shown) to draw water from the water reservoir 11 to supply the heating element 12 with water. Alternatively, the water could be supplied from the water reservoir 11 to the heating element 12 by the force of gravity if the water reservoir 11 is mounted above the heating element 12. The apparatus could also employ a valve (not shown) located between the water reservoir 11 and the heating element 12 to supply only desired amounts or flow rates of water to the heating element 12.

Preferably, the water reservoir 11 can be removed for filling. Otherwise, it can have an inlet or connector that can be used to fill it.

The vacuum assembly 2 preferably includes a vacuum fan 21 driven by an electric motor, a waste reservoir 23, a vacuum hose 22 connected to an opening of the operating nozzle assembly 6 through which matter is drawn by the vacuum fan 21 to the waste reservoir 23. A filter 24 is positioned upstream of the fan 21. The fan has three outlets, namely one connected to an exhaust valve 26 for venting air, one connected to an air supply pipe 25 leading to an air heating assembly 3, and one connected to an air supply pipe 45 of a treatment substance supply assembly 4.

It is preferred that the vacuum hose 22 has a smooth bore which prevents the bed bugs from clinging to and remaining in the vacuum.

Preferably, the waste reservoir 23 can be removed. It may be desirable to establish fluid-tight connections between the waste reservoir 23 and the vacuum fan 21 and the vacuum hose 22. Preferably, the waste reservoir 23 can be provided with a door (not shown) which is removable, hinged, slidable, or otherwise openable with respect to adjacent walls of the waste reservoir 23.

The air heating assembly 3 preferably includes an air supply pipe 33, which is connected to the exhaust from the fan 21 of the vacuum assembly 2 for supplying exhaust from the vacuum assembly 2 to the air heating assembly 3. The heating element 31 heats the exhaust from the vacuum fan 21 and a blower hose 32 channels the heated air to the mixing chamber 5, in which the heated air and steam mix and exit through an opening to the operating nozzle 6.

The heating element 31 can be sheathed and located within the air heating assembly 3 to be directly contacted by the exhaust from the vacuum assembly 2 to the air heating assembly 3. Any suitable heating element of the prior art can be used for heating the air.

The air heating assembly 3 heats the air, and the hot air mixes with the steam from the steam generating assembly 1, so the steam used in the apparatus is essentially dry steam (i.e. with little or no fluid water). Therefore, the surface that is treated can be kept essentially dry, by immediately removing the steam before there is any opportunity to condense to any significant degree. The air heating assembly also uses the vacuum fan 21, instead of a separate fan, thus reducing the amperage needed to run all functions, and thus saving energy and simplifying the operation and structure of the apparatus.

Referring to FIG. 2, the insulated steam hose 13 runs inside the blower hose 32, preferably concentrically. The air gap created by the differences in tube diameters protects the exterior tube from getting too hot and potentially dangerous to handle. It can also prevent steam in the steam hose 13 from condensing and turning into water. The insulated steam hose can be held concentrically periodically along the length of the blower hose 32 with small clips (not shown). Alternatively, the steam hose 13 and blower hose 32 can be separated. Optionally, the steam hose 13 and the blower hose 32 can run and mix in one hose, eliminating the need for the mixing chamber 5.

The treatment substance dispensing assembly 4 preferably includes a treatment substance reservoir 41 to contain a treatment substance that can be used to kill bed bugs or other pests, a treatment substance hose 42 and a treatment substance dispensing nozzle 43 for spraying the treatment substance upon the surfaces to be treated.

The treatment substance that can be used in the apparatus may vary depending upon the type of pest to be eradicated. The treatment substance could be a chemical treatment substance or a natural treatment substance; it could be a powder, small solid particles, or a liquid. For example, the treatment substance could be a powder such as diatomaceous earth for killing bed bugs.

Preferably but not necessarily, the force for spraying the treatment substance is supplied by the vacuum fan 21. The treatment substance reservoir 41 is connected to the fan exhaust by air supply pipe 45. The flow of the treatment substance to treatment substance dispensing nozzle 43 can be controlled by controlling the flow of air from the fan exhaust by a valve 47 on the pipe 45.

Alternatively, a separate pump could be used to supply the force needed to dispense the treatment substance. Optionally, the treatment substance dispensing assembly 4 can be a manually-operated sprayer for dispensing a chemical.

Preferably, the flow of treatment substance in the treatment substance reservoir 41 to the treatment substance dispensing nozzle 43 can be controlled by the operator using a hand manipulated valve 44 in the treatment substance hose 42.

The treatment substance dispensing nozzle 43 preferably is attached to the outside of the operating nozzle 6. However, it should be slightly away or offset from the operating nozzle, so that the powder or other treatment substance is not simply vacuumed up by the operating nozzle. Preferably, the treatment substance dispensing nozzle 43 therefore is offset and directed at an angle away from the outlet of the operating nozzle 6, so the treatment substance is dispensed on the treated area without being affected by the suctioning of the vacuum.

The operating nozzle 6 is used to spray the steam/ heated air mixture on the surface to be treated, and to then immediately suction it away from the surface. The nozzle 6 needs to be designed in a way that each element does not interfere with the other, i.e. the steam/heated air or “steam nozzle” 62 needs to be slightly separated from the vacuum inlet or “vacuum nozzle” 61.

Referring to FIG. 2, in one example, the operating nozzle 6 includes two separate nozzles, namely a vacuum nozzle 61 and a steam nozzle 62. Ribs or the like, or a bracket arrangement, keep the two nozzles somewhat separated so that the functions do not interfere with each other unduly.

With the vacuum nozzle, steam nozzle and treatment substance dispensing nozzle suitably secured in proximity to each other as a nozzle unit, an operator can move the nozzle unit appropriately across the surface so as to apply the dry steam, then apply the vacuum, and then apply the treatment substance.

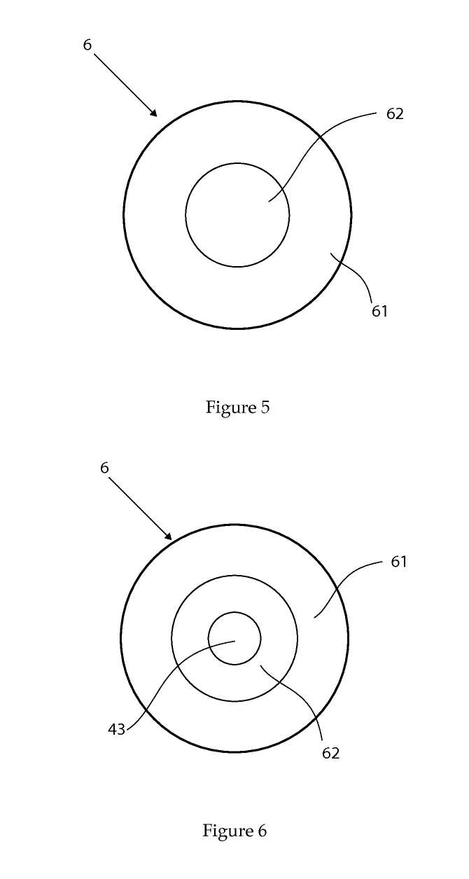

In another embodiment, as shown in FIG. 5, the operating nozzle 6 features two concentric ports. The center port emits the steam and heat mixture whereas the outermost ring is used for the vacuum. The concentric design is preferred as it allows for the operator to move the nozzle in any direction.

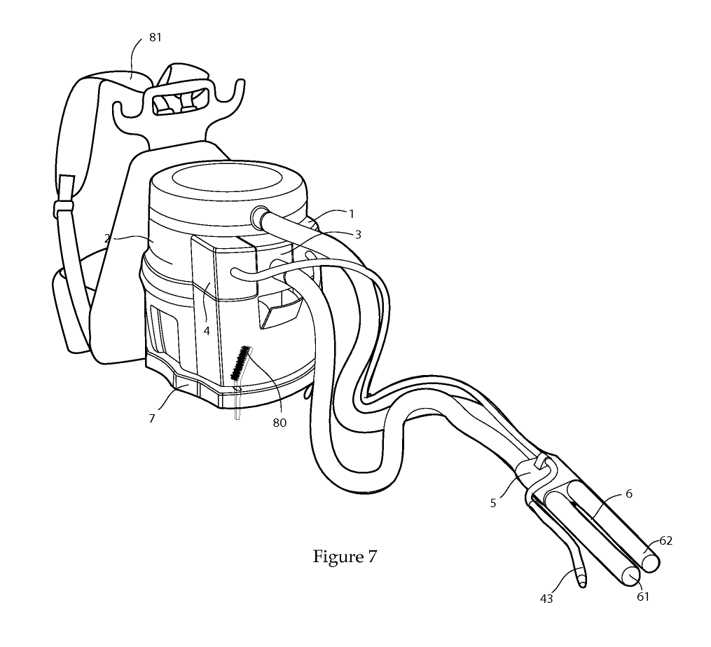

As another alternative, as shown in FIG. 6, the operating nozzle 6 features three concentric ports for heat/steam 62, vacuum 61 and treatment substance 43. In such an embodiment, it is preferable that the three elements can be switched on and off independently, to avoid for example the treatment substance being vacuumed up as soon as it is applied.

However, a consequence of this design is that live bugs may be vacuumed into the waste reservoir 23 prior to being exterminated. Three solutions to this problem are considered. A first option is to superheat the vacuum hose such that as the bugs travel through the hose the exposure to the hot air would exterminate them prior to arriving in the waste reservoir 23. A second option would be to heat the waste reservoir 23 to a sufficient temperature such that any bugs still alive are guaranteed to be exterminated. A third and preferred option is to have a sealable vacuum bag which contains an amount of the treatment substance used in the treatment substance dispensing assembly 4 (such as diatomaceous earth), ensuring the bugs are eventually exterminated and sealed in the sealable vacuum bag.

The operating nozzle 6, connected to the body assembly (including the steam generating assembly 1, the vacuum assembly 2, the air heating assembly 3 and the treatment substance dispensing assembly 4) via hoses and tubing, preferably is a hand-held unit which when manipulated makes it very easy to direct and apply the heated steam, vacuum and treatment substance. The operating nozzle 6 preferably includes various mounts to receive and connect the various hoses from the body assembly as well as mounts to attach other nozzle attachments (extension tubes, flexible crevice tools, upholstery tool, and surface agitators such as a brush 80), a switch for the heating elements, a selectively controllable switch for each function, and suitable gripping areas for maximum control and manipulation.

Preferably the apparatus incorporates a failsafe switch on the operating nozzle 6 which specifically controls the heating elements. The switch when engaged turns the heating apparatus on and when disengaged turns the heating apparatus off. Another embodiment incorporates a temperature sensor and automatic shut off near or preferably attached to the body assembly which provides additional safety measures to ensure the heating apparatus doesn't overheat.

Referring to FIG. 1, for improved ability to manipulate and control the apparatus, the body assembly, comprising the steam generating assembly 1, the vacuum assembly 2, the air heating assembly 3 and the treatment substance dispensing assembly 4, are preferably mounted on a base assembly 7 which preferably is provided with wheels for ease of movement.

In some embodiments, as shown in FIG. 7, the body assembly may be connected to a lightweight chassis assembly with flexible ergonomic straps to be worn by the operator and used as a portable backpack unit.

If desired, the base or chassis assembly may also include tools such as brushes or the like to agitate the surface or access narrow spaces.

During operation of the apparatus, the user removes the water reservoir 11 for filling at least partially with water, or otherwise fills the water reservoir 11 while on the steam generating assembly 1. The user then turns on the heating element 12 to heat water, and steam is thereafter generated within the water reservoir 11 and is transferred through insulated steam hose 13. At the same time, the user can turn on the power to drive the vacuum fan 21 and to generate suction through the vacuum nozzle 61, to draw dirt, soil, dust and other debris through the vacuum nozzle 61 and into the waste reservoir 23, where the air is then separated from the solids, with the solids settling to the bottom of the waste reservoir 23. The air then exits the waste reservoir 23 through the filter 24 and then exits the waste reservoir 23 through the vacuum exhaust 25. Part of the air is drawn to the air heating assembly 3 through air supply pipe 33. The heating element 31 heats the air and sends it to the blower hose 32. The steam and the heated air meet in the mixing chamber 5 and the steam is further heated by the hot air. As a result of the additional heat, the steam turns into dry steam and is sprayed from steam nozzle 62 of the operating nozzle 6. The high temperature steam cleans the surface and kills bed bugs or other pests. The vacuum nozzle 61 sucks the dead bed bugs or other pests to the waste reservoir. At the same time, the user can also spray treatment substance onto the surface. The bed bugs can also be killed by the treatment substance and be sucked to the waste reservoir. When the cleaning is completed, the user can move to another spot. When all the cleaning is completed, the user can turn off all power and preferably empty the waste reservoir 23.

Other embodiments of the invention permit a user to switch between full treatment mode which has all features functioning (steam, heat, vacuum and treatment substance), vacuum cleaning mode, heated steam treating mode, and treatment substance application mode by manipulating a switch connected to the operating nozzle. Furthermore, a preferred embodiment would have the temperature and steam intensity adjustable via a user manipulated control (such as dial or knob) near the body assembly and connected either to the air heating assembly or steam apparatus.

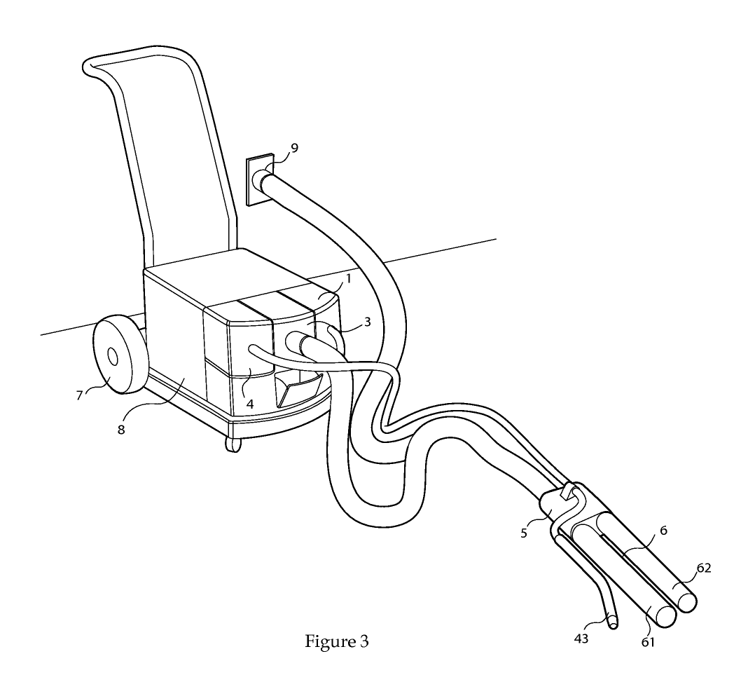

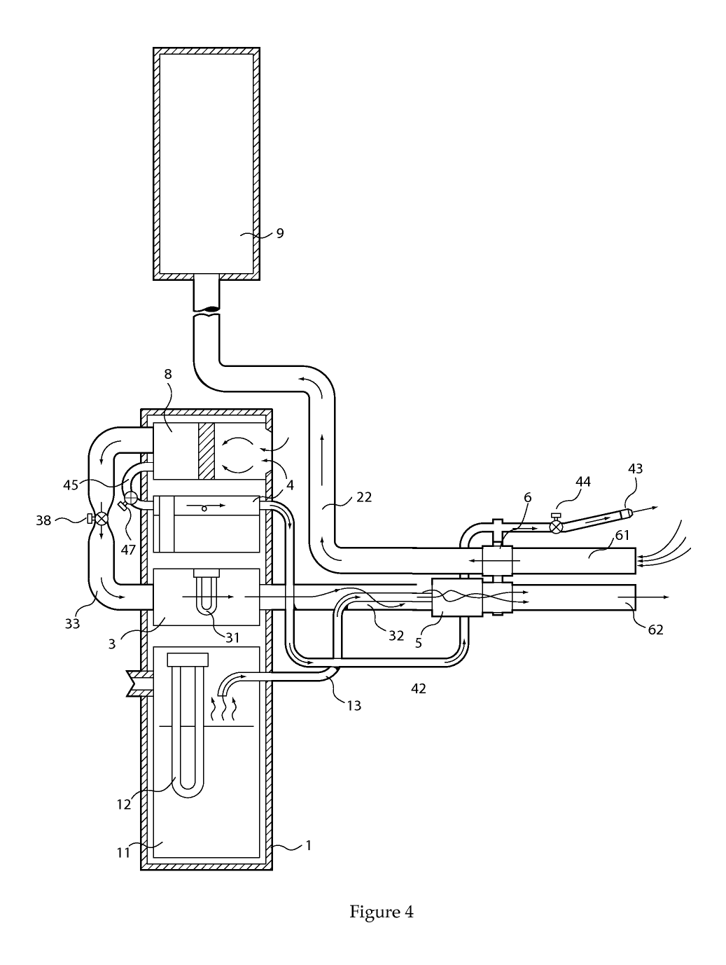

Referring to FIGS. 3 and 4, another example of the dry steamer pest control apparatus is shown, configured to attach to and use the pre-existing central vacuum units in a house or other edifice. The body assembly in this embodiment does not need to accommodate the vacuum assembly 2, but does require an additional fan 8 for the air heating assembly 3 and the treatment substance dispensing assembly 4.

Specifically, the dry steamer pest control apparatus of this embodiment includes: a steam generating assembly 1 for generating and delivering steam; an additional fan 8; a heating element 3 for heating and delivering the air from the additional fan 8; a treatment substance dispensing assembly 4 for dispensing treatment substances onto a surface to be treated; a mixing chamber 5 for mixing steam from the steam generating assembly 1 and hot air from the heating element assembly 3; and an operating nozzle assembly 6, for spraying the steam/heat mixture from the mixing chamber 5 and drawing air for the central vacuum 9.

Referring to FIG. 4, in this example the vacuum nozzle 61 is connected to the central vacuum by a hose. The air heated in the air heating assembly 3 is from the additional fan 8, and therefore the air supply pipe 33 is connected to one of the outlets of the additional fan 8. Also, the power for spraying the treatment substance is supplied by the additional fan 8, and therefore the air supply pipe 45 is connected to one outlet of the additional fan 8. The flow of the treatment substance in the treatment substance dispensing nozzle 43 can be controlled by controlling the flow of the air from the additional fan 8. Other parts are essentially as described in relation to the embodiment of FIGS. 1 and 2.

During operation of the apparatus of the FIGS. 3 and 4 embodiment, the user removes the water reservoir 11 for filling at least partially with water, or otherwise fills the water reservoir 11. The user turns on the heating element 12 to heat water, and steam is thereafter generated within the water reservoir 11 and is transferred through the insulated steam hose 13. At the same time, the user can connect the vacuum nozzle 61 to the central vacuum with a hose, to generate a vacuum through the nozzle 61. Dirt, soil, dust and other debris are thereby drawn up into the operating nozzle 61 and into the central vacuum system. At the same time, turning on the additional fan 8 sends air to the air heating assembly 3 through air supply pipe 33. The heating element 31 heats the air and sends it to the blower hose 32. The steam and the heated air meet in the mixing chamber 5 and the steam is further heated by the hot air. The steam turns into dry steam and is sprayed from the steam nozzle 62 of the operating nozzle 6. The high temperature steam cleans the surface and kills bed bugs or other pests. The vacuum nozzle 61 sucks the dead bed bugs or other pests to the central vacuum system. At the same time, the user can also spray treatment substance onto the surface. Bed bugs or other pests can also be killed by the treatment substance and be sucked to the central vacuum system. When the cleaning is completed, the user can move to another spot. When all the cleaning is completed, the user can turn the power switch to its off position.

Preferably, the apparatus is powered by connecting to any standard electrical outlet and drawing power from one 15 or 20 amp circuit. In some preferred embodiments, the body assembly could be powered by other means such as generators, battery packs or liquid fuel.

It will be evident to those knowledgeable in the field of the invention that many variations on the example described above are conceivable within the scope of the invention. It should therefore be understood that the claims which define the invention are not restricted to the specific examples described above.

1. Apparatus for dry steam pest control and/or dry steam cleaning, comprising:
a steam generating assembly for generating and delivering steam via a steam nozzle to a surface to be treated;
an air heating assembly for heating and delivering hot air to mix with said steam prior to exiting said steam nozzle, to produce dry steam; and
a vacuum nozzle for connection to a vacuum unit for drawing exterminated pests and/or other debris away from the surface.

2. Apparatus as in claim 1, wherein said vacuum unit is a part of said apparatus, and wherein said steam generating assembly, said air heating assembly and said vacuum unit are combined in one unit.

3. Apparatus as in claim 2, wherein said vacuum unit comprises a fan connected to said vacuum nozzle to draw air through said vacuum nozzle, and an exhaust supplying air to said air heating assembly for heating and delivering to mix with said steam.

4. Apparatus as in claim 1, further comprising a treatment substance dispensing assembly for dispensing a treatment substance onto the surface via a treatment substance dispensing nozzle.

5. Apparatus as in claim 2, further comprising a treatment substance dispensing assembly for dispensing a treatment substance onto the surface via a treatment substance dispensing nozzle.

6. Apparatus as in claim 5, wherein said vacuum unit comprises a fan connected to said vacuum nozzle to draw air through said vacuum nozzle, a first exhaust supplying air to said air heating assembly for heating and delivering to mix with said steam, and a second exhaust connected to said treatment substance dispensing assembly to supply air to deliver said treatment substance to said treatment substance dispensing nozzle.

7. Apparatus as in claim 1, wherein said steam nozzle and said vacuum nozzle are secured in proximity to each other as a nozzle unit, whereby an operator can move the nozzle unit across the surface so as to apply the dry steam and then apply the vacuum.

8. Apparatus as in claim 4, wherein said steam nozzle, said vacuum nozzle and said treatment substance dispensing nozzle are secured in proximity to each other as a nozzle unit, whereby an operator can move the nozzle unit across the surface so as to apply the dry steam, then apply the vacuum, and then apply the treatment substance.

9. Apparatus as in claim 1, wherein said vacuum nozzle is connectable to a vacuum system which is separate from the apparatus.

10. Apparatus as in claim 9, further comprising a treatment substance dispensing assembly for dispensing a treatment substance onto the surface via a treatment substance dispensing nozzle.

11. Apparatus as in claim 9, wherein said steam nozzle and said vacuum nozzle are secured in proximity to each other as a nozzle unit, whereby an operator can move the nozzle unit across the surface so as to apply the dry steam and then apply the vacuum.

12. Apparatus as in claim 10, wherein said steam nozzle, said vacuum nozzle and said treatment substance dispensing nozzle are secured in proximity to each other as a nozzle unit, whereby an operator can move the nozzle unit across the surface so as to apply the dry steam, then apply the vacuum, and then apply the treatment substance.
